(19) United States
(12) Patent Application Publication
(10) Pub. No.: US 2025/0056361 A1
(43) Pub. Date: Feb. 13, 2025

(54) MOBILITY PROCEDURE

(71) Applicant: Nokia Technologies Oy, Espoo (FI)

(72) Inventors: Panagiotis SPAPIS, Munich (DE); Umur KARABULUT, Munich (DE); Srinivasan SELVAGANAPATHY, Bangalore (IN); Behnam KHODAPANAH, Munich (DE)

(21) Appl. No.: 18/783,014

(22) Filed: Jul. 24, 2024

(30) Foreign Application Priority Data
Aug. 11, 2023 (IN) 202341054064

(51) Int. Cl. H04W 36/30; H04W 12/041; H04W 12/043; H04W 76/19

(52) U.S. Cl. CPC H04W 36/305; H04W 12/041; H04W 12/043; H04W 76/19

(57) ABSTRACT

According to an example aspect of the present invention, there is provided an apparatus configured to determine a radio link failure with a main cell group while operating in dual connectivity with selective activation of primary secondary cell change, SAPC, configurations stored for a set of secondary cells, determine a new secondary node encryption key based at least in part on a master node key received from a master node during a connection re-establishment of a connection with the master node after the radio link failure to the main cell group comprising the master node has occurred, and after the radio link failure, identify a secondary cell using the SAPC configurations stored before the radio link failure, and connect to the identified secondary cell based at least in part on the new secondary node encryption key.

### FIELD

The present disclosure relates to mobility procedures in cellular communication networks.

### BACKGROUND

In cellular communication networks, user equipments attach themselves to cells to access services of the network, such as connectivity, positioning and telephony. As user equipments roam within a coverage area of the network, they change attachment from cell to cell, to maintain a viable communication path to the network side.

In the event of radio link failure, RLF, with a base station of the network the affected user equipment may take corrective actions, such as request re-establishment of the radio link with the network. To alleviate effects of RLFs on connectivity, user equipments may be provided with simultaneous radio links to more than one base station, or cell.

### SUMMARY

According to some aspects, there is provided the subject-matter of the independent claims. Some embodiments are defined in the dependent claims. The scope of protection sought for various embodiments of the invention is set out by the independent claims. The embodiments, examples and features, if any, described in this specification that do not fall under the scope of the independent claims are to be interpreted as examples useful for understanding various embodiments of the invention.

According to a first aspect of the present disclosure, there is provided an apparatus comprising at least one processing core and at least one memory storing instructions that, when executed by the at least one processing core, cause the apparatus at least to determine a radio link failure with a main cell group while operating in dual connectivity with selective activation of primary secondary cell change, SAPC, configurations stored for a set of secondary cells, determine a new secondary node encryption key based at least in part on a master node key received from a master node during a connection re-establishment of a connection with the master node after the radio link failure to the main cell group comprising the master node has occurred, and after the radio link failure, identify a secondary cell using the SAPC configurations stored before the radio link failure, and connect to the identified secondary cell based at least in part on the new secondary node encryption key.

According to a second aspect of the present disclosure, there is provided an apparatus comprising at least one processing core and at least one memory storing instructions that, when executed by the at least one processing core, cause the apparatus at least to provide to a user equipment selective activation of primary secondary cell change, SAPC, configurations for a set of secondary cells while operating as a master node in dual connectivity session of the user equipment, determine a new secondary node encryption key based at least in part on a master node key determined by the apparatus as a response to receiving a connection re-establishment request or a reconfiguration complete message from the user equipment after a radio link failure has occurred, and update, after the radio link failure, the set of secondary cells with the new secondary node encryption key without providing to the set of secondary cells a user equipment context.

According to a third aspect of the present disclosure, there is provided a method, comprising determining, in an apparatus, a radio link failure with a main cell group while operating in dual connectivity with selective activation of primary secondary cell change, SAPC, configurations stored for a set of secondary cells, determining a new secondary node encryption key based at least in part on a master node key received from a master node during a connection re-establishment of a connection with the master node after the radio link failure to the main cell group comprising the master node has occurred, and after the radio link failure, identifying a secondary cell using the SAPC configurations stored before the radio link failure, and connect to the identified secondary cell based at least in part on the new secondary node encryption key.

According to a fourth aspect of the present disclosure, there is provided a method, comprising provide, by an apparatus to a user equipment selective activation of primary secondary cell change, SAPC, configurations for a set of secondary cells while operating as a master node in dual connectivity session of the user equipment, determining a new secondary node encryption key based at least in part on a master node key determined by the apparatus as a response to receiving a connection re-establishment request or a reconfiguration complete message from the user equipment after a radio link failure has occurred, and updating, after the radio link failure, the set of secondary cells with the new secondary node encryption key without providing to the set of secondary cells a user equipment context.

According to a fifth aspect of the present disclosure, there is provided an apparatus comprising means for determining, in an apparatus, a radio link failure with a main cell group while operating in dual connectivity with selective activation of primary secondary cell change, SAPC, configurations stored for a set of secondary cells, determining a new secondary node encryption key based at least in part on a master node key received from a master node during a connection re-establishment of a connection with the master node after the radio link failure to the main cell group comprising the master node has occurred, and after the radio link failure, identifying a secondary cell using the SAPC configurations stored before the radio link failure, and connecting to the identified secondary cell based at least in part on the new secondary node encryption key.

According to a sixth aspect of the present disclosure, there is provided an apparatus comprising means for providing to a user equipment selective activation of primary secondary cell change, SAPC, configurations for a set of secondary cells while operating as a master node in dual connectivity session of the user equipment, determining a new secondary node encryption key based at least in part on a master node key determined by the apparatus as a response to receiving a connection re-establishment request or a reconfiguration complete message from the user equipment after a radio link failure has occurred, and updating, after the radio link failure, the set of secondary cells with the new secondary node encryption key without providing to the set of secondary cells a user equipment context.

According to a seventh aspect of the present disclosure, there is provided an apparatus comprising at least one processing core and at least one memory storing instructions that, when executed by the at least one processing core, cause the apparatus at least to receive, from a node acting as master node in a dual connectivity session of the user equipment, a secondary node encryption key and a context of the user equipment as part of a selective activation of primary secondary cell change, SAPC, set-up, receive from the node acting as the master node a new secondary node encryption key, such that the context of the user equipment is not updated, and receive, after receiving the new secondary node encryption key, from the user equipment a connection request based on the SAPC set-up.

According to an eighth aspect of the present disclosure, there is provided a non-transitory computer readable medium having stored thereon a set of computer readable instructions that, when executed by at least one processor, cause an apparatus to at least determine a radio link failure with a main cell group while operating in dual connectivity with selective activation of primary secondary cell change, SAPC, configurations stored for a set of secondary cells, determine a new secondary node encryption key based at least in part on a master node key received from a master node during a connection re-establishment of a connection with the master node after the radio link failure to the main cell group comprising the master node has occurred, and after the radio link failure, identify a secondary cell using the SAPC configurations stored before the radio link failure, and connect to the identified secondary cell based at least in part on the new secondary node encryption key.

According to a ninth aspect of the present disclosure, there is provided a non-transitory computer readable medium having stored thereon a set of computer readable instructions that, when executed by at least one processor, cause an apparatus to at least provide to a user equipment selective activation of primary secondary cell change, SAPC, configurations for a set of secondary cells while operating as a master node in dual connectivity session of the user equipment, determine a new secondary node encryption key based at least in part on a master node key determined by the apparatus as a response to receiving a connection re-establishment request or a reconfiguration complete message from the user equipment after a radio link failure has occurred, and update, after the radio link failure, the set of secondary cells with the new secondary node encryption key without providing to the set of secondary cells a user equipment context.

### BRIEF DESCRIPTION OF THE DRAWINGS

FIG. 1 illustrates an example system in accordance with at least some embodiments of the present invention;

FIG. 2 illustrates an example signalling flow in accordance with at least some embodiments of the present invention;

FIG. 3 illustrates an example signalling flow in accordance with at least some embodiments of the present invention;

FIG. 4 illustrates an example apparatus capable of supporting at least some embodiments of the present invention, and

FIG. 5 is a flow graph of a method in accordance with at least some embodiments of the present invention.

### EMBODIMENTS

Described herein are methods to reduce delays in a cellular system caused by radio link failure, RLF, to a cell in a main cell group. In detail, selective activation of primary secondary cell change, SAPC, configurations in the user equipment, UE, are maintained over the RLF, and UE contexts in secondary cells prepared for the UE are likewise maintained, such that the SAPC configurations and UE context need not be provided again to the UE and the prepared secondary cells, respectively. After the RLF, the master node from the main cell group merely updates the UE and prepared secondary nodes with new encryption key information in the form of a new secondary node key to the secondary nodes, and a new master node key to the UE.

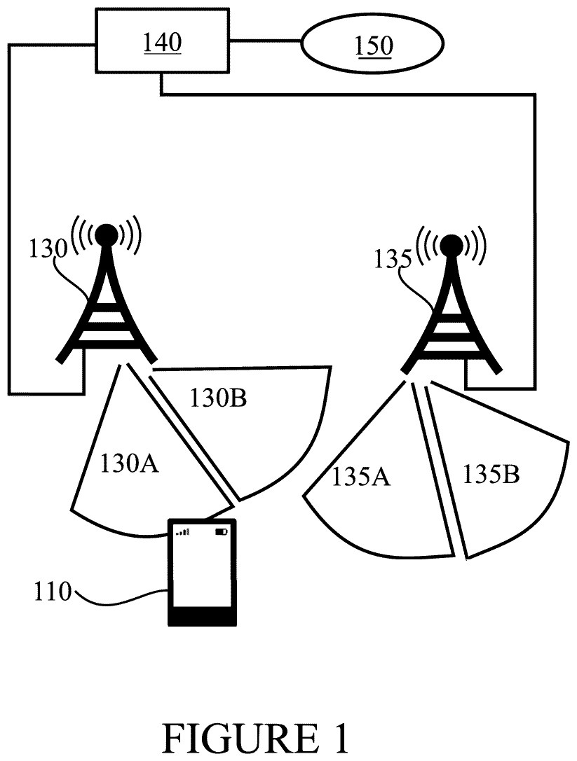

FIG. 1 illustrates an example system in accordance with at least some embodiments of the present invention. This system includes a base stations 130, 135 in communication with UEs, such as UE 110. A radio link connects base station 130 with UE 110, The radio link may be bidirectional, comprising an uplink, UL, to convey information from UE 110 toward base station 130 and a downlink, DL, to convey information from the base station 130 toward UE 110. Base station 130 may be a master node in a dual connectivity session of UE 110, where base station 135 is a secondary node. By dual connectivity it is meant a session where the UE utilizes the radio resources of plural carriers to increase UE throughput.

Dual connectivity, DC, is a mode of operation where a multiple receive and transmission capable UE in radio resource control, RRC, connected state can be configured to use radio resource of two distinct schedulers, located in two base stations, namely a master base station, known as master node, MN, and a secondary base station, known as secondary node, SN. MN and SN may be connected to each other via a back-haul connection, such as an inter-base station interface, such as, for example, an X2 interface in 3rd generation partnership project, 3GPP, systems. In other words, DC allows a UE to simultaneously transmit and receive data on multiple component carriers from two cell groups via MN and SN. The MN is comprised in a main cell group, MCG, while SN is comprised in a secondary cell group, SCG.

Base stations 130 and 135 are further coupled communicatively with core network node 140, which may comprise, for example, a mobility management entity, MME, or access and mobility management function, AMF. The core network node 140 may be coupled with further core network nodes, and with a network 150, which may comprise the Internet or a corporate network, for example. The system may communicate with further networks via network 150. Examples of the further core network nodes, which are not illustrated in FIG. 1 for the sake of clarity, include gateways and subscriber information repositories.

Base station 130 has plural cells 130A, 130B, of which UE 110 is in the situation illustrated in FIG. 1 attached with cell 130A, and base station 135 has plural cells 135A, 135B. The number of cells may be in excess of what is illustrated in FIG. 1. A mobility event may comprise a switch from one cell, or beam, to another cell or beam of the same base station, or a switch from one base station to another base station. To support mobility procedures, UEs are configured to conduct measurements to measure signal strengths of adjacent beams and/or cells, and report results of these measurements to the network. The network may then take a decision concerning a mobility event, such as a beam change or a cell switch, based at least in part on the reported measurement results.

Such mobility measurements at the UE side may comprise layer-3 measurements, and the corresponding reports are layer-3, or L3, reports. Likewise a handover command from the network is typically a layer-3 message. Layer 3 is in technology standardized by the 3rd generation partnership project, 3GPP, the radio resource control, RRC, layer. Of the lower layers layer-1, or L1, is in 3GPP technology the physical layer, and layer-2, or L2, comprises the medium access control, MAC, radio link control, RLC, and packet data convergence protocol, PDCP, protocols.

When mobility measurements indicate that a signal strength of a cell, or beam, the UE is currently attached with is declining and a signal strength of another cell, or beam, is increasing, a switch to the another cell or beam may be commanded by the network, based at least in part on mobility measurement reporting from the UE.

Selective activation of primary secondary cell change, SAPC, configurations may be provided to the UE by the MN. A SAPC configuration may comprise conditions relating to selecting a new secondary cell, such as, for example, a primary secondary cell, PSCell. More specifically, a SAPC configuration may comprise conditions specific to a candidate secondary cell, which define circumstances in which the UE should initiate a process to change the primary secondary cell to this candidate secondary cell. The UE may evaluate the conditions to thereby, conditionally, initiate a change of the primary secondary cell. The primary secondary cell is a cell among the secondary cell group to which the UE initiates connectivity to within the secondary cell group. Likewise the UE exchanges more signalling with the primary secondary cell, than other secondary cells. SAPC conditions comprised in a SAPC configuration may comprise conditions concerning reference signal received power, RSRP, from a secondary cell, conditions concerning a current location of the UE, and conditions concerning buffer status of the UE, for example. For example, a SAPC configuration may define that all the SAPC conditions of the configuration must be satisfied at the same time, for the configuration to trigger the UE to initiate a primary secondary cell change.

In principle, in case an RLF takes place with a cell in the main cell group, in particular if the RLF involves the MN, the UE may discard SAPC configurations it has received from the MN, since connectivity to this node is, at least temporarily, lost. However it has been surprisingly discovered, that since the UE will remain in the physical neighbourhood of the MN and of the secondary cell(s) the SAPC configuration(s) involve, the SAPC configuration(s) may be retained for possible use after, and even during, the RLF, as will be herein described in more detail. Likewise, rather than abandoning UE contexts of the user equipment, SNs prepared to accept the UE may retain these contexts through an RLF of the UE with the MN. The MN may send to the prepared SNs a new SN encryption key to update their preparation to receive the UE, and the MN may likewise send a new master node key, MN key, to the UE after the RLF, to update the SAPC configurations which may otherwise be used as stored in the UE before the RLF.

Before the RLF, the UE may indicate to the MN that it has the capability to retain SAPC configurations over an RLF with the MN, and the MN may responsively instruct the UE to use this capability and retain SAPC configurations, should an RLF take place between the UE and the MN. Once the MN has so configured the UE, the MN may also cause the SNs to retain the UE context, rather than discarding it, in case of RLF between the UE and the MN or another main cell group node. If the SNs discarded the UE context, it might have to be re-provided from the MN, needlessly increasing signalling load in the network.

The UE context comprises information on active protocol connections of the UE, such as information identifying the communication counterpart and packet counter values, which are needed in providing a seamless, or more fluent, cell change. The UE context may store UE state information, security information and UE capability information in addition to information on an active protocol connection of the UE.

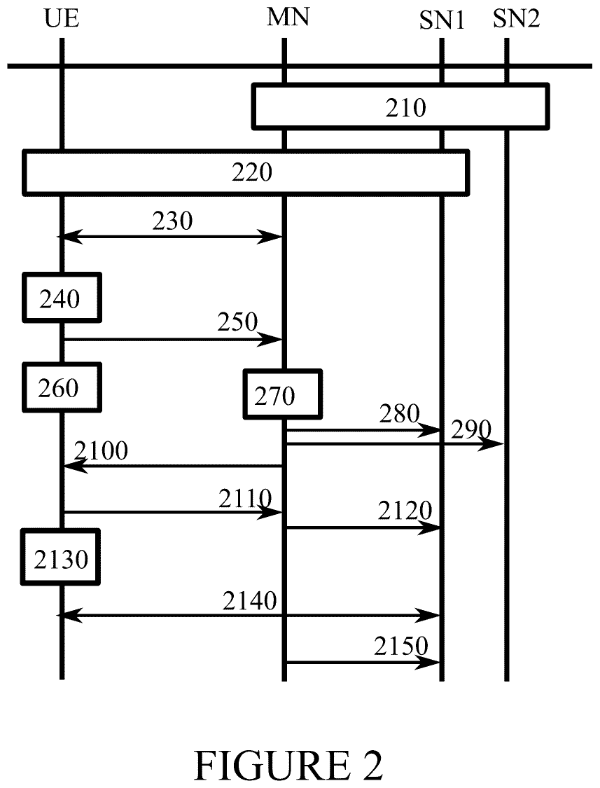

FIG. 2 illustrates an example signalling flow in accordance with at least some embodiments of the present invention. On the vertical axes are disposed, from left to right, the UE, the MN, and at least one secondary node, e.g. two secondary nodes, SN1 and SN2. Time advances from the top toward the bottom.

In phase 210, the MN prepares SN1 and SN2 for SAPC with the UE, by providing, for example, the UE context and an SN encryption key to these nodes. With this information, these nodes are prepared to initiate communications with the UE, such that these communications are secured and encrypted over the air interface using the SN encryption key. SN encryption key, Ksx, may be generated using a key generator. Inputs for the key generator may comprise, for example, MN key, e.g. KgNB, SN counter and SN counter length. To run the key generator, the UE draws a next counter value from an SN counter list. The SN counter list may be provided to the UE by MN, for example when the MN configures the UE to setup a link with an SN. Once the SN counter list is provided to the UE, the UE will also know the SN counter lengths, as the counter is explicit. As such, the UE will know all three inputs needed for SN key generation: the MN key, the SN counter and the SN counter length. When the UE is prepared for plural candidate SNs, the UE may be provided a separate list of counters for each candidate SN. If the UE switches to a new PSCell, it may draw a new value from the list of counters of the target cell to generate a suitable SN key. The SN counter information may be provided to the UE from MN in an RRC reconfiguration or RRC re-establishment message, for example.

Serving SN may need to know the SN key the UE will use to have end-to-end cyphering. Since the MN determines the SN counter value for the UE, the MN already knows the key that will be generated by the UE using the SN counter. The MN may calculate the SN key using the appropriate counter value and send the SN key to be used to the SN before that SN becomes the serving SN, for example in SN addition or change. In either case, SN addition or SN change, the MN may share the SN key Ksx with the candidate SN during the preparation, e.g. via an SN addition request message. If there are multiple PSCells preparation requested in one SN addition request message message, all of the prepared PSCells will share the same KsN.

Further before or after phase 210, the MN may configure the UE to retain SAPC configurations over an RLF with the MN. To enable the MN to instruct the UE so, the UE may first provide to the MN an indication that the UE has this capability, as described herein above.

In phase 220, the UE is in dual connectivity with the MN and SN1. The UE may be configured with SAPC for SN1 and SN2. Phase 230 represents an RLF with the MN. The RLF may be caused by suddenly worsened radio conditions, for example due to an interference spike. The UE responds to the RLF of phase 230 by starting cell reselection in phase 240. The SAPC configurations provided before the RLF of phase 230 are retained in the UE and not discarded or deleted. In some embodiments, the UE begins evaluation of the SAPC conditions of the retained SAPC configurations in phase 240.

In phase 250, the UE transmits to the MN a RRC re-establishment request. The MN may detect or determine the RLF based on the received RRC re-establishment request. Optionally, this message comprises a primary secondary cell, PSCell, identifier, selected based on evaluating the SAPC conditions in phase 240. In case a SAPC condition is fulfilled for any of the SNs (SN1 or SN2) before transmitting the RRC re-establishment request, the UE may indicate this to the MN with the cells this condition is fulfilled. A SAPC condition may be referred to as a conditional PSCell change, CPC, condition. For example, identifier of the node or cell fulfilling the condition may be included in the RRC re-establishment request. Including the primary secondary cell identifier already in this message saves time in the process and enables the UE to benefit substantially from retaining the SAPC configurations over the RLF.

Phase 260 comprises the UE evaluating the SAPC conditions, for example in case the primary secondary cell identifier was not already included in the RRC message of phase 250 or in case the evaluation has not already been initiated in phase 240. If the primary secondary cell identifier was already sent to the MN in phase 250, phase 260 may be skipped.

In phase 270 the MN determines or generates or calculates a new SN encryption key as a response to the RRC re-establishment request of phase 250, and this new SN encryption key is provided to SN1 and SN2 in phases 280 and 290, as illustrated in the figure. Optionally, SN1 and SN2 may acknowledge receipt of the new SN encryption key. SN1 and SN2 thus have the UE context, stored already prior to RLF 230, and the new SN encryption key provided to them in phases 280 and 290. The MN is aware of the prepared SNs through the UE context. The MN may generate the key using the key generator described above.

In phase 2100 the MN provides to the UE an RRC re-establishment response as a response to the RRC re-establishment request of phase 250. The response of phase 2100 comprises an MN RRC re-configuration. The message of phase 2100 comprises a new master node encryption key. The message of phase 2100 may comprise instructions for the UE to maintain the SN counter list. In an example, the MN will send a new SN counter list for a target cell to be used in key generation. Optionally, the MN can directly configure dual connectivity with the selected PSCell in phase 2100, in case the UE provided to the MN the identifier of the selected PSCell that has fulfilled the SAPC conditions already before, in the RRC re-establishment request of phase 250. The UE responds by sending to the MN a RRC re-establishment complete message as phase 2110 and the MN provides the RRC re-establishment complete message to SN1 comprising the selected PSCell in phase 2120.

In phase 2130, the UE identifies the PSCell to connect to by evaluating the SAPC conditions unless this was already done earlier. The UE generates or calculates the new SN encryption key from the master node encryption key received in phase 2100 and using the SN counter information maintained in the UE from before the RLF of phase 230. The UE may generate the key using the key generator described above. In phase 2140 the UE performs a random access process with SN1 to establish a SN leg of a DC session. In phase 2150 the MN may transfer SN status to SN1.

The process of FIG. 2 saves time compared to the case where SAPC configurations in the UE are discarded, since evaluating the SAPC conditions in phase 240, 260 or 2130 is enabled to take place earlier than could be possible in case the MN had to pre-prepare the SNs for SAPC, and provide the SAPC configurations to the UE again after the RRC connection re-establishment.

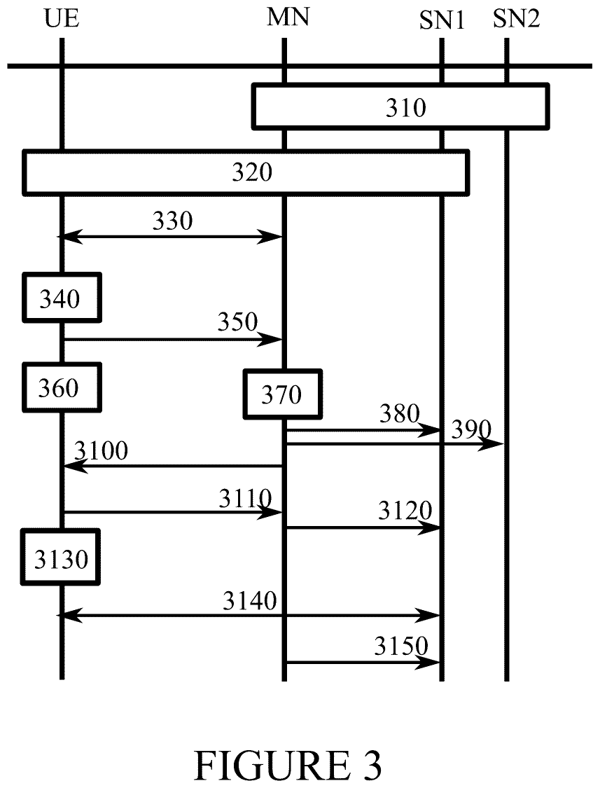

FIG. 3 illustrates an example signalling flow in accordance with at least some embodiments of the present invention. The process of FIG. 3 resembles that of FIG. 2, and the vertical axes correspond to the same nodes as in FIG. 2. The process of FIG. 3 is a conditional handover, CHO, recovery. The procedure is similar to that described above for the RRC re-establishment of FIG. 2, with the difference that RRC reconfigurations are used, as mandated in CHO recovery, instead of RRC re-establishment.

Further before or after phase 310, the MN may configure the UE to retain SAPC configurations over an RLF with the MN. To enable the MN to instruct the UE so, the UE may first provide to the MN an indication that the UE has this capability, as described herein above. Phases 310, 320, 330, 340 and 360 correspond to phases 210, 220, 230, 240 and 260.

Phase 350 comprises a transmission, from the UE to the MN, of a RRC reconfiguration complete. The MN may detect or determine the RLF based on the received RRC reconfiguration complete message. Optionally, the UE informs the MN if conditional PSCell change conditions, these being the SAPC condition(s) is, or are, fulfilled for any of the SN already at this stage. In case a SAPC condition is fulfilled before transmitting the RRC reconfiguration complete message, the UE may indicate this to the MN with the cells this condition is fulfilled. For example, an identifier of the node or cell fulfilling the condition may be included in the RRC reconfiguration complete message.

Phase 370 corresponds to phase 270, wherein the MN determines a new SN encryption key, and provides this to the SNs in phases 380 and 390. As was the case in FIG. 2, the SNs may, optionally, acknowledge receipt of the new SN encryption key. The SNs now have the new SN encryption key and the UE context, stored already before the RLF of phase 330. The MN is aware of the prepared SNs through the UE context.

In phase 3100, the MN provides to the UE an RRC reconfiguration message, comprising a MN RRC reconfiguration. This message comprises a new MN encryption key. In case the identifier of a PSCell which satisfies the SAPC conditions was provided to the MN in phase 350, this message of phase 3100 may also include an instruction to start a DC session with MN as master node and the cell identified in phase 350 as the PSCell. The message of phase 3100 may comprise instructions for the UE to maintain the SN counter list. In an example, the MN will send a new SN counter list for a target cell to be used in key generation. The UE responds to the message of phase 3100 by transmitting, in phase 3110, an RRC re-establishment complete message to the MN. In phase 3120, the MN forwards the RRC re-establishment complete message to SN1 comprising the identified PSCell.

In phase 3130, the UE identifies the PSCell to connect to by evaluating the SAPC conditions unless this was already done earlier. The UE generates or calculates the new SN encryption key from the master node encryption key received in phase 3100 and using the SN counter information maintained in the UE from before the RLF of phase 330. In phase 3140 the UE performs a random access process with SN1 to establish a SN leg of a DC session. In phase 3150 the MN may transfer SN status to SN1

As was the case in the process of FIG. 2, also the process of FIG. 3 saves time compared to the case where SAPC configurations in the UE are discarded, since evaluating the SAPC conditions in phase 340, 360 or 3130 is enabled to take place earlier than could be possible in case the MN had to pre-prepare the SNs for SAPC, and provide the SAPC configurations to the UE again after the RRC connection re-establishment.

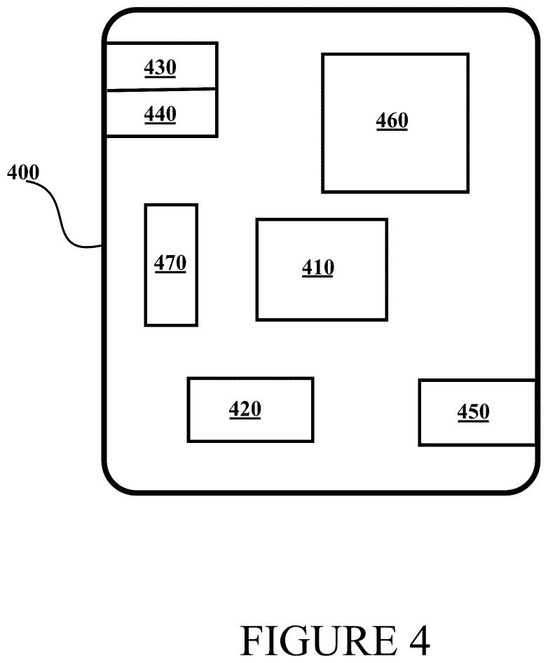

FIG. 4 illustrates an example apparatus capable of supporting at least some embodiments of the present invention. Illustrated is device 400, which may comprise, for example, a mobile communication device such UE or, in applicable parts, a base station. Comprised in device 400 is processor 410, which may comprise, for example, a single- or multi-core processor wherein a single-core processor comprises one processing core and a multi-core processor comprises more than one processing core. Processor 410 may comprise, in general, a control device. Processor 410 may comprise more than one processor. When processor 410 comprises more than one processor, device 400 may be a distributed device wherein processing of tasks takes place in more than one physical unit. Processor 410 may be a control device. A processing core may comprise, for example, a Cortex-A8 processing core manufactured by ARM Holdings or a Zen processing core designed by Advanced Micro Devices Corporation. A processing core or processor may be, or may comprise, at least one qubit. Processor 410 may comprise at least one Qualcomm Snapdragon and/or Intel Atom processor. Processor 410 may comprise at least one application-specific integrated circuit, ASIC. Processor 410 may comprise at least one field-programmable gate array, FPGA. Processor 410, optionally together with memory and computer instructions, may be means for performing method steps in device 400, such as determining, identifying, receiving, transmitting, beginning, updating and providing. Processor 410 may be configured, at least in part by computer instructions, to perform actions.

A processor may comprise circuitry, or be constituted as circuitry or circuitries, the circuitry or circuitries being configured to perform phases of methods in accordance with embodiments described herein. As used in this application, the term “circuitry” may refer to one or more or all of the following: (a) hardware-only circuit implementations, such as implementations in only analogue and/or digital circuitry, and (b) combinations of hardware circuits and software, such as, as applicable: (i) a combination of analogue and/or digital hardware circuit(s) with software/firmware and (ii) any portions of hardware processor(s) with software (including digital signal processor(s)), software, and memory (ies) that work together to cause an apparatus, such as UE or base station, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Device 400 may comprise memory 420. Memory 420 may comprise random-access memory and/or permanent memory. Memory 420 may comprise at least one RAM chip. Memory 420 may be a computer readable medium. Memory 420 may comprise solid-state, magnetic, optical and/or holographic memory, for example. Memory 420 may be at least in part accessible to processor 410. Memory 420 may be at least in part comprised in processor 410. Memory 420 may be means for storing information. Memory 420 may comprise computer instructions that processor 410 is configured to execute. When computer instructions configured to cause processor 410 to perform certain actions are stored in memory 420, and device 400 overall is configured to run under the direction of processor 410 using computer instructions from memory 420, processor 410 and/or its at least one processing core may be considered to be configured to perform said certain actions. Memory 420 may be at least in part external to device 400 but accessible to device 400. Memory 420 may be transitory or non-transitory. The term “non-transitory”, as used herein, is a limitation of the medium itself (that is, tangible, not a signal) as opposed to a limitation on data storage persistency (for example, RAM vs. ROM).

Device 400 may comprise a transmitter 430. Device 400 may comprise a receiver 440. Transmitter 430 and receiver 440 may be configured to transmit and receive, respectively, information in accordance with at least one cellular or non-cellular standard. Transmitter 430 may comprise more than one transmitter. Receiver 440 may comprise more than one receiver. Transmitter 430 and/or receiver 440 may be configured to operate in accordance with global system for mobile communication, GSM, wideband code division multiple access, WCDMA, 5G, long term evolution, LTE, IS-95, wireless local area network, WLAN, Ethernet and/or worldwide interoperability for microwave access, WiMAX, standards, for example.

Device 400 may comprise a near-field communication, NFC, transceiver 450. NFC transceiver 450 may support at least one NFC technology, such as NFC, Bluetooth, Wibree or similar technologies.

Device 400 may comprise user interface, UI, 460. UI 460 may comprise at least one of a display, a keyboard, a touchscreen, a vibrator arranged to signal to a user by causing device 400 to vibrate, a speaker or a microphone. A user may be able to operate device 400 via UI 460, for example to accept incoming telephone calls, to originate telephone calls or video calls, to browse the Internet, to manage digital files stored in memory 420 or on a cloud accessible via transmitter 430 and receiver 440, or via NFC transceiver 450, and/or to play games.

Device 400 may comprise or be arranged to accept a user identity module 470. User identity module 470 may comprise, for example, a subscriber identity module, SIM, card installable in device 400. A user identity module 470 may comprise information identifying a subscription of a user of device 400. A user identity module 470 may comprise cryptographic information usable to verify the identity of a user of device 400 and/or to facilitate encryption of communicated information and billing of the user of device 400 for communication effected via device 400.

Processor 410 may be furnished with a transmitter arranged to output information from processor 410, via electrical leads internal to device 400, to other devices comprised in device 400. Such a transmitter may comprise a serial bus transmitter arranged to, for example, output information via at least one electrical lead to memory 420 for storage therein. Alternatively to a serial bus, the transmitter may comprise a parallel bus transmitter. Likewise processor 410 may comprise a receiver arranged to receive information in processor 410, via electrical leads internal to device 400, from other devices comprised in device 400. Such a receiver may comprise a serial bus receiver arranged to, for example, receive information via at least one electrical lead from receiver 440 for processing in processor 410. Alternatively to a serial bus, the receiver may comprise a parallel bus receiver.

Device 400 may comprise further devices not illustrated in FIG. 4. For example, where device 400 comprises a smartphone, it may comprise at least one digital camera. Some devices 400 may comprise a back-facing camera and a front-facing camera, wherein the back-facing camera may be intended for digital photography and the front-facing camera for video telephony. Device 400 may comprise a fingerprint sensor arranged to authenticate, at least in part, a user of device 400. In some embodiments, device 400 lacks at least one device described above. For example, some devices 400 may lack a NFC transceiver 450 and/or user identity module 470.

Processor 410, memory 420, transmitter 430, receiver 440, NFC transceiver 450, UI 460 and/or user identity module 470 may be interconnected by electrical leads internal to device 400 in a multitude of different ways. For example, each of the aforementioned devices may be separately connected to a master bus internal to device 400, to allow for the devices to exchange information. However, as the skilled person will appreciate, this is only one example and depending on the embodiment various ways of interconnecting at least two of the aforementioned devices may be selected without departing from the scope of the present invention.

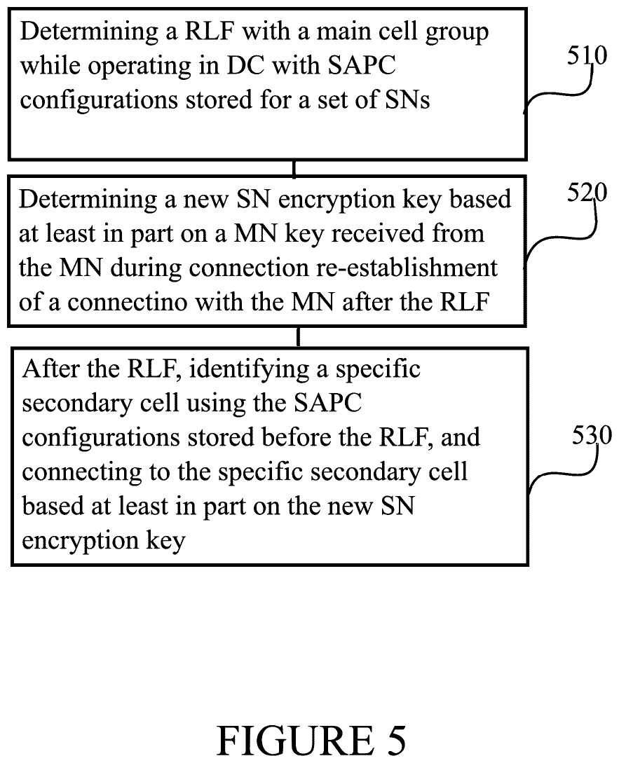

FIG. 5 is a flow graph of a method in accordance with at least some embodiments of the present invention. The phases of the illustrated method may be performed in a user equipment or in a control device configured to control the functioning thereof, when installed therein.

Phase 510 comprises determining, in an apparatus, a radio link failure with a main cell group while operating in dual connectivity with selective activation of primary secondary cell change, SAPC, configurations stored for a set of secondary cells. Phase 520 comprises determining a new secondary node encryption key based at least in part on a master node key received from the master node during a connection re-establishment of a connection with the master node after the radio link failure to the main cell group has occurred. Finally, phase 530 comprises, after the radio link failure, identifying a specific secondary cell using the SAPC configurations stored before the radio link failure, and connecting to the specific secondary cell based at least in part on the new secondary node encryption key.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the preceding description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

### INDUSTRIAL APPLICABILITY

At least some embodiments of the present invention find industrial application in cellular networking.

ACRONYMS LIST

| | |
|---|---|
| 3GPP | 3^{rd} generation partnership project |
| DC | dual connectivity |
| MN | master node |
| RRC | radio resource control |
| SAPC | selective activation of primary secondary cell change |
| SN | secondary node |
| UE | user equipment |

REFERENCE SIGNS LIST

| | |
|---|---|
| 110 | user equipment |
| 130, 135 | base station |
| 140 | core network node |
| 150 | network |
| 130A, 130B, | cells |
| 135A, 135B | |
| 210-2150 | phases of signalling in FIG. 2 |
| 310-3150 | phases of signalling in FIG. 3 |
| 400-470 | structure of the device of FIG. 4 |
| 510-530 | phases of the method of FIG. 5 |

1. An apparatus comprising at least one processing core and at least one memory storing instructions that, when executed by the at least one processing core, cause the apparatus at least to:
determine a radio link failure with a main cell group while operating in dual connectivity with selective activation of primary secondary cell change, SAPC, configurations stored for a set of secondary cells;
determine a new secondary node encryption key based at least in part on a master node key received from a master node during a connection re-establishment of a connection with the master node after the radio link failure to the main cell group comprising the master node has occurred, and
after the radio link failure, identify a secondary cell using the SAPC configurations stored before the radio link failure, and connect to the identified secondary cell based at least in part on the new secondary node encryption key.

2. The apparatus according to claim 1, further configured to receive, from the network, an instruction to maintain SAPC configurations in case of radio link failure with a main cell group.

3. The apparatus according to claim 1, further configured to transmit, to the network, an indication that the apparatus is capable of using, after the radio link failure with the main cell group, the SAPC configurations stored in the apparatus before the radio link failure with the main cell group.

4. The apparatus according to claim 1, wherein the apparatus is configured to: begin evaluation of at least one condition comprised in the SAPC configurations after the radio link failure with the main cell group and one of:
before transmitting a connection re-establishment request to the master node or;
before transmitting a reconfiguration complete message to the master node.

5. The apparatus of claim 4, wherein the apparatus is configured to identify the secondary cell based on the evaluation of the at least one condition, wherein the identified secondary cell fulfills the at least one condition, and the apparatus is further configured to; indicate the identified secondary cell to the master node in the connection re-establishment request or in the reconfiguration complete message.

6. The apparatus of claim 45, wherein the apparatus is configured to identify the secondary cell based on the evaluation of the at least one condition, wherein the identified secondary cell fulfills the at least one condition, and the apparatus is further configured to: indicate the identified secondary cell to the master node in the connection re-establishment request or in the reconfiguration complete message; and
receive a configuration to start dual connectivity with the identified secondary cell.

7. The apparatus of claim 1, configured to determine the new secondary node encryption key based at least in part on a secondary node, SN, counter list, and wherein the apparatus is configured to:
receive instructions to maintain the SN counter list provided before the radio link failure; or
receive the SN counter list to be used in key generation.

8. An apparatus comprising at least one processing core and at least one memory storing instructions that, when executed by the at least one processing core, cause the apparatus at least to:
provide to a user equipment selective activation of primary secondary cell change, SAPC, configurations for a set of secondary cells while operating as a master node in dual connectivity session of the user equipment;
determine a new secondary node encryption key based at least in part on a master node key determined by the apparatus as a response to receiving a connection re-establishment request or a reconfiguration complete message from the user equipment after a radio link failure has occurred, and
update, after the radio link failure, the set of secondary cells with the new secondary node encryption key without providing to the set of secondary cells a user equipment context.

9. The apparatus according to claim 8, configured to: provide to the set of secondary nodes the user equipment context before the radio link failure.

10. The apparatus according to claim 8, further configured to: provide to the user equipment an instruction to maintain SAPC configurations in case of radio link failure with a main cell group.

11. The apparatus according to claim 8, further configured to: receive, from the user equipment, the connection re-establishment request or the reconfiguration complete message identifying a secondary cell fulfilling at least one condition comprised in the SAPC configurations.

12. The apparatus according to claim 11, further configured to transmit a configuration to start dual connectivity with the identified secondary cell.

13. The apparatus of claim 8, configured to determine
the new secondary node encryption key based at least in part on a secondary node, SN, counter list, and wherein the apparatus is further configured to:
transmit, to the user equipment, an instruction to maintain the SN counter list provided before the radio link failure; or
transmit, to the user equipment, the SN counter list to be used in key generation.

14. A method, comprising:
determining, in an apparatus, a radio link failure with a main cell group while operating in dual connectivity with selective activation of primary secondary cell change, SAPC, configurations stored for a set of secondary cells;
determining a new secondary node encryption key based at least in part on a master node key received from a master node during a connection re-establishment of a connection with the master node after the radio link failure to the main cell group comprising the master node has occurred, and
after the radio link failure, identifying a secondary cell using the SAPC configurations stored before the radio link failure, and connect to the identified secondary cell based at least in part on the new secondary node encryption key.

15. The method according to claim 14, further comprising receiving, from the network, an instruction to maintain SAPC configurations in case of radio link failure with a main cell group.

16. The method according to claim 14, further comprising transmitting, to the network, an indication that the apparatus is capable of using, after the radio link failure with the main cell group, the SAPC configurations stored in the apparatus before the radio link failure with the main cell group.

17. The method according to claim 14, wherein the method comprises: beginning evaluation of at least one condition comprised in the SAPC configurations after the radio link failure with the main cell group and one of:
before transmitting a connection re-establishment request to the master node or;
before transmitting a reconfiguration complete message to the master node.

18. The method of claim 17, wherein the method comprises identifying the secondary cell based on the evaluation of the at least one condition, wherein the identified secondary cell fulfills the at least one condition, and the method further comprises: indicating the identified secondary cell to the master node in the connection re-establishment request or in the reconfiguration complete message.

19. The method of claim 18, wherein the method comprises identifying the secondary cell based on the evaluation of the at least one condition, wherein the identified secondary cell fulfills the at least one condition, and the method further comprises: indicating the identified secondary cell to the master node in the connection re-establishment request or in the reconfiguration complete message; and
receiving a configuration to start dual connectivity with the identified secondary cell.

20. The method of claim 14, comprising determining the new secondary node encryption key based at least in part on a secondary node, SN, counter list, and wherein the method comprises:
receiving instructions to maintain the SN counter list provided before the radio link failure; or
receiving the SN counter list to be used in key generation.

21-31. (canceled)
